(19) United States
(12) Patent Application Publication
(10) Pub. No.: US 2026/0172852 A1
(43) Pub. Date: Jun. 18, 2026

(54) Dynamic Self-scaling UL PHY Algorithms Using Turbo Boost

(71) Applicant: Parallel Wireless, Inc., Nashua, NH (US)

(72) Inventors: Christopher Smart, Royal Wootton Bassett, Wiltshire (GB); Przemyslaw Czerepinski, Bradley Stoke, Bristol (GB); Evgeny Tsimbalo, Bristol (GB)

(21) Appl. No.: 19/401,353

(22) Filed: Nov. 25, 2025

Related U.S. Application Data
(60) Provisional application No. 63/724,899, filed on Nov. 25, 2024.

(51) Int. Cl. H04W 24/02; H04L 25/02

(52) U.S. Cl. CPC H04W 24/02; H04L 25/0202

(57) ABSTRACT

This invention exploits episodes of additional capacity in the uplink physical layer of a mobile communications base station. It describes how a predefined set of signal processing blocks can detect the current Turbo Boost status and execute an algorithm with additional complexity and greater performance than the baseline algorithm whenever Turbo Boost is found to be active.

### CROSS-REFERENCE TO RELATED APPLICATIONS

This application claims the benefit under 35 U.S.C. § 119 (e) or PCT Article 8 (1), whichever is deemed presently applicable, of U.S. Provisional Application No. 63/724,899, filed in the U.S.A., having the same title as the present application and filed Nov. 25, 2024, which is hereby incorporated by reference in its entirety.

This application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; US20170257133A1; and US20200128414A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1, US20200128414A1, US20230019380A1 in their entirety. Features and characteristics of and pertaining to the systems and methods described in the present disclosure, including details of the multi-RAT nodes and the gateway described herein, are provided in the documents incorporated by reference.

### BACKGROUND

Turbo Boost is a feature on some modern CPUs whereby the processor clock speed automatically increases on an opportunistic and temporary basis, providing episodes of additional processing capacity on the device. However, turbo boost is not typically used in a telecom context; for example, some competitors require all cores to be locked to their maximum rated speed. Various processors, some used in telecom servers, provide a number of energy saving and power boosting features as standard, with most effort so far concentrated on the energy saving potential. Features such as Intel Speed Select Technology and AMD Core Performance Boost are referred to hereafter, for brevity, as Turbo Boost in the present document. It is understood that turbo boost exists on other processors as well as these specific processors, and that other processors' similar features are considered equivalent to the turbo boost features discussed herein.

The 3rd Generation Partnership Project (3GPP) has, since at least 2017 with 3GPP TR 38.801 V14.0.0. (2017 March) (hereby incorporated by reference in its entirety), considered the benefits of splitting various functional blocks across the DU (Distributed Unit), CU (Centralized Unit), and more recently including 5G splits across a Near-RT (Real-Time) and Non-RT (Real-Time) RIC (RAN Intelligence Controller). Additionally and in concert, the Open Radio Access Network (Open RAN) is a movement in wireless telecommunications to disaggregate hardware, such as RRH (Remote Radio Head), and software, such as the Physical Layer (PHY) and higher layer functions, and to create open interfaces between them. Open RAN has published specifications for the 4G and 5G radio access technologies (RATs).

Open Radio Access Network (Open RAN) is a movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Open RAN has published specifications for the 4G and 5G radio access technologies (RATs).

### SUMMARY

A method for dynamically self-scaling uplink physical layer (UL PHY) algorithms in a mobile communications base station may comprise detecting the current Turbo Boost state of a processor in the base station and executing an enhanced algorithm with greater complexity and increased processing demands, resulting in improved wireless performance, when Turbo Boost is active, thereby enabling the mobile communications base station to opportunistically exploit additional processing capacity provided by Turbo Boost, thereby enhancing the performance of UL PHY algorithms.

In some embodiments, detecting the current Turbo Boost state of the processor in the base station may be performed each time the UL PHY algorithms execute. In some embodiments, the method may further comprise executing a baseline algorithm when Turbo Boost is inactive.

In some embodiments, the increased number of decoder iterations for 5G NR Low-Density Parity Check (LDPC) decoding and 4G LTE Turbo decoding, when Turbo Boost is active, may improve the UL Block Error Ratio (BLER) and increase the UL data throughput. In some embodiments, the method may further comprise allowing an increased number of decoder iterations for one of 5G NR Low-Density Parity Check (LDPC) decoding and 4G LTE Turbo decoding when Turbo Boost is active, thereby improving the UL Block Error Ratio (BLER) and increasing the UL data throughput.

In some embodiments, the method may further comprise employing an increased number of channel estimation anchors for one of 5G NR and 4G LTE channel estimation and equalization when Turbo Boost is active, thereby providing finer time-domain or frequency-domain resolution in an equalizer, leading to improved UL BLER performance and higher throughput. In some embodiments, the method may further comprise selecting between the baseline Minimum Mean Square Error (MMSE) algorithm and a more sophisticated MMSE-Interference Rejection Combining (IRC) algorithm based on the Turbo Boost status.

In some embodiments, the method may further comprise determining a degree of boost in terms of a proportional increase in clock speed above the baseline, and tuning an enhanced algorithm using the determined degree of boost, wherein a higher degree of boost may allow for a higher level of algorithmic complexity. In some embodiments, the Turbo Boost state may be used to control a number of Forward Error Correction (FEC) decoding iterations, allowing additional iterations to be scheduled opportunistically based on the status of decoder output and Turbo Boost.

### BRIEF DESCRIPTION OF THE DRAWINGS

FIG. 1 is a schematic diagram showing radio functional splits, in accordance with the prior art.

FIG. 2 is a schematic diagram showing an architecture of a digital radio receiver in a 4G or 5G radio base station, in accordance with some embodiments.

FIG. 3 is a first flow diagram showing execution using a turbo boost state block, in accordance with some embodiments.

FIG. 4 is a second flow diagram showing execution using a turbo boost state block, in accordance with some embodiments.

FIG. 5 is a third flow diagram showing execution using a turbo boost state block, in accordance with some embodiments.

FIG. 6 is a flow diagram showing a controller block with multiple inputs, in accordance with some embodiments.

FIG. 7 is a fourth flow diagram showing execution using a turbo boost state block, in accordance with some embodiments.

FIG. 8 is a schematic diagram of a multi-RAT RAN deployment architecture, in accordance with some embodiments.

### DETAILED DESCRIPTION

Turbo Boost allows a processor to opportunistically promote a set of CPU cores to higher than its rated “all-cores” clock speed, based on the number of active cores and the power and thermal headroom on the device. For example, on the AMD Epyc 8324P we can see the 2.65 GHz rated clock speed temporarily boosted to 3.0 GHz when sufficient cores within the device are idle and sufficient power and thermal headroom is available. At the boosted clock speed, each active processor core will be able to perform more operations during a prescribed realtime period (such as the 500 us slot duration in 5G NR) and so is capable of supporting an increase in the processing workload.

A key differentiator in the mobile communication systems developed by Parallel Wireless is the use of commercial off-the-shelf (COTS) servers rather than custom silicon. This is especially noteworthy in the Virtualised Baseband Unit (VBBU) which implements the functionality of a 3GPP base station using essentially an all-software solution running on standard servers that might be found in a typical datacentre. The processors used in these servers, such as Intel Xeon, provide a number of energy saving and power boosting features as standard, with most effort so far concentrated on the energy saving potential. While Intel Xeon chips are currently used, additional chips could be used as well and are contemplated as equivalent for the purposes of the present disclosure if possessing turbo boost-like functionality. Features such as Intel Speed Select Technology and AMD Core Performance Boost (referred to hereafter, for brevity, as Turbo Boost) have yet to be utilised.

The problem with the use of Turbo Boost, and the reason why it has not yet been exploited in the VBBU, is that it only provides additional processing capacity on an opportunistic and temporary basis—it cannot be relied upon to provide a consistent level of CPU performance. In the VBBU we therefore scale our CPU capacity requirements according to how much processing resource we need given a processor running at its rated “all-cores” maximum clock speed. The telecom field has previously not had obvious application for Turbo Boost as the processor is capable of completing all its realtime processing demands within the required duration while remaining at its rated frequency.

The solution proposed by this invention is to introduce a new class of signal processing functional blocks in the VBBU, in some embodiments in the uplink (UL) physical layer (PHY), which will dynamically self-scale in terms of algorithmic complexity according to the current Turbo Boost state. These functional blocks will be extensions to the existing UL PHY implementations, whereby they will, in some embodiments: detect the current Turbo Boost state, for example by inspecting device Model Specific Registers (MSR), each time they execute; if Turbo Boost is found to be inactive then the standard (i.e., baseline) algorithm will be performed; if Turbo Boost is found to be active then an enhanced algorithm with greater complexity and increased processing demands, and as a consequence improved wireless performance, will be performed.

By dynamically selecting algorithms of higher complexity when additional processing capacity becomes available through Turbo Boost, self-scaling is achieved. This self-scaling approach allows the system to automatically adapt its computational complexity without external intervention or manual configuration changes. The functional blocks monitor their own processing environment and autonomously switch between baseline and enhanced algorithms based on real-time processor performance states. This creates an intelligent system that maximizes performance opportunities while maintaining reliable and predictable operation under all conditions.

It will be appreciated that, while the standard UL PHY algorithms provide an acceptable level of wireless performance, the enhanced algorithms will provide improved performance such that increases in UL data throughput and/or user capacity can be realised whenever the conditions for Turbo Boost are met.

Although the UL performance gains can only be realised when Turbo Boost is opportunistically active, and so are not guaranteed to be available at any time, the benefits are significant and often material in telecom environments where heavy workloads occur in a bursty and unpredictable fashion.

In some embodiments, the technology described herein may result in energy savings through reduced processing time when Turbo Boost is active. The improved performance provided by enhanced algorithms may allow signals to be successfully decoded with fewer retransmissions, reducing the total energy consumed per successfully decoded message. When enhanced algorithms improve the Block Error Ratio, the base station may require fewer processing cycles overall to successfully recover transmitted data, as the probability of successful decoding on the first attempt increases.

In some embodiments, improved UL BLER performance may mean fewer block errors and fewer retransmissions required from user equipment, saving energy both at the UE and at the base station. Reduced retransmissions at the UE may extend battery life for mobile devices, as transmitting data consumes significant power. At the base station, fewer retransmissions may reduce the processing load and associated energy consumption, as the system does not need to repeatedly process the same data blocks. Where improvements are described herein, it is understood that the measurement instrumentation needed to assess BLER and other measures of signal quality are present in the 4G/5G/etc. standard and in the network, such that the improvements are able to be detected using well-understood methods and without additional technology, in some embodiments.

In some embodiments, the system may make productive use of available thermal and power headroom without requiring additional energy input by exploiting idle periods during Turbo Boost opportunities. As noted elsewhere in this specification, Turbo Boost opportunities are expected in lightly- or moderately-loaded scenarios or where processing load is not equally distributed between CPU resources. By opportunistically using idle core capacity during these periods, the system may extract additional performance from energy that would otherwise be dissipated as waste heat, effectively improving the energy efficiency of the overall system.

In some embodiments, this invention may work in tandem with energy-saving modes, creating a dynamic energy-performance optimization strategy. The specification notes that most effort so far has concentrated on the energy saving potential of features like Intel Speed Select Technology and AMD Core Performance Boost. The present invention may complement these energy-saving features by using baseline algorithms during energy-saving periods and enhanced algorithms during Turbo Boost periods, allowing the system to dynamically balance energy consumption with performance requirements based on current operating conditions.

In some embodiments, opportunistically improving performance during Turbo Boost periods may allow operators to meet performance targets with less over-provisioned hardware, potentially reducing the total number of servers or cores needed in a deployment and saving infrastructure energy. By extracting higher performance from existing hardware during periods when additional capacity is available, operators may be able to achieve required service levels without deploying additional servers, thereby reducing the total energy footprint of the network infrastructure. This may be particularly beneficial in scenarios where peak performance requirements are infrequent or bursty in nature.

The set of UL PHY functional blocks that can benefit from this invention includes, but is not limited to, the following: 5G NR Low-Density Parity Check (LDPC) decoding (when Turbo Boost is active an increased number of decoder iterations can be allowed, improving the UL Block Error Ratio (BLER) and therefore increasing the UL data throughput); 4G LTE Turbo decoding (when Turbo Boost is active an increased number of decoder iterations can be allowed, improving the UL BLER and therefore increasing the UL data throughput); 5G NR and 4G LTE channel estimation and equalization (when Turbo Boost is active an increased number of channel estimation anchors can be employed, providing a finer time- or frequency-domain resolution in the equalizer leading to improved UL BLER performance, and higher throughput); 5G NR and 4G LTE equalizer selection (the status of Turbo Boost can be used to select between the baseline Minimum Mean Square Error (MMSE) algorithm and the more sophisticated MMSE-Interference Rejection Combining (IRC) approach).

In some embodiments, an additional mechanism or software block could provide an extension to this basic Turbo Boost detection and exploitation mechanism would be to determine the degree of boost, in terms of the proportional increase in clock speed above the baseline, and then tune the enhanced algorithm accordingly-a higher degree of boost would allow for a higher level of algorithmic complexity. In some embodiments, heat output or constraints of the system could be used to determine whether or not to use Turbo Boost or Turbo Boost-enabled algorithms.

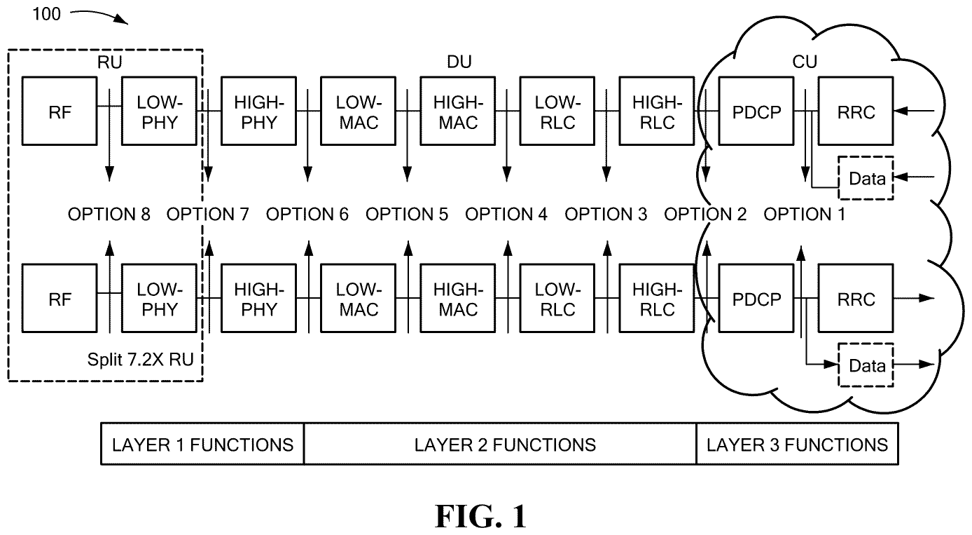

FIG. 1 is a schematic diagram showing radio functional splits, in accordance with the prior art. FIG. 1 shows a schematic diagram of radio functional splits showing split 7.2×RU as well as other splits. The use of these functional splits is encouraged by ORAN.

5G New Radio (NR) was designed to allow for disaggregating the baseband unit (BBU) by breaking off functions beyond the Radio Unit (RU) into Distributed Units (DUs) and Centralized Units (CUs), which is called a functional split architecture. This concept has been extended to 4G as well.

RU: This is the radio hardware unit that coverts radio signals sent to and from the antenna into a digital signal for transmission over packet networks. It handles the digital front end (DFE) and the lower PHY layer, as well as the digital beamforming functionality. 5G RU designs are supposed to be inherently intelligent, but the key considerations of RU design are size, weight, and power consumption. Deployed on site.

DU: The distributed unit software that is deployed on site on a COTS server. DU software is normally deployed close to the RU on site and it runs the RLC, MAC, and parts of the PHY layer. This logical node includes a subset of the eNodeB (eNB)/gNodeB (gNB) functions, depending on the functional split option, and its operation is controlled by the CU.

CU: The centralized unit software that runs the Radio Resource Control (RRC) and Packet Data Convergence Protocol (PDCP) layers. The gNB consists of a CU and one DU connected to the CU via Fs-C and Fs-U interfaces for CP and UP respectively. A CU with multiple DUs will support multiple gNBs. The split architecture lets a 5G network utilize different distributions of protocol stacks between CU and DUs depending on midhaul availability and network design. It is a logical node that includes the gNB functions like transfer of user data, mobility control, RAN sharing (MORAN), positioning, session management etc., except for functions that are allocated exclusively to the DU. The CU controls the operation of several DUs over the midhaul interface. CU software can be co-located with DU software on the same server on site.

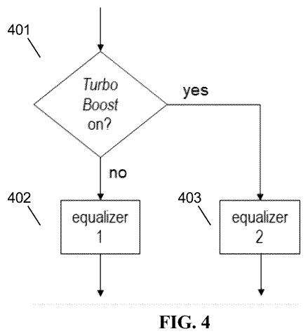

When the RAN functional split architecture (FIG. 4) is fully virtualized, CU and DU functions runs as virtual software functions on standard commercial off-the-shelf (COTS) hardware and be deployed in any RAN tiered datacenter, limited by bandwidth and latency constraints.

Option 7.2 (shown) is the functional split chosen by the O-RAN Alliance for 4G and 5G. It is a low-level split for ultra-reliable low-latency communication (URLLC) and near-edge deployment. RU and DU are connected by the eCPRI interface with a latency of ˜100 microseconds. In O-RAN terminology, RU is denoted as O-RU and DU is denoted as O-DU. Further information is available in US20200128414A1, hereby incorporated by reference in its entirety.

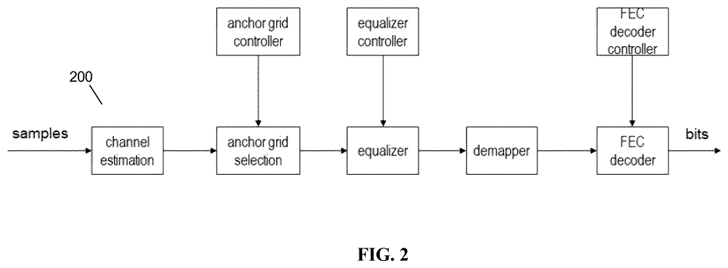

FIG. 2 is a schematic diagram showing an architecture of a digital radio receiver in a 4G or 5G radio base station, in accordance with some embodiments. FIG. 2 illustrates a schematic diagram of the digital part of a physical layer (PHY) receiver. The receiver comprises several functional blocks arranged in a signal processing chain. An input signal enters a Channel Estimation (CE) block, which estimates the distortion to which the signal was subjected while traveling between the transmitter and receiver. The output of the CE block feeds into an anchor grid selection block, which may select a subset of CE outputs as a basis for calculating equalizer coefficients, trading off complexity and performance. The anchor grid selection is controlled by an anchor grid controller. The selected anchor grid information is then passed to an equalizer block, which forms estimates of the transmitted signal samples. The equalizer selection is controlled by an equalizer controller that may select between different equalizer variants, such as MMSE or MMSE-IRC equalizers. The equalizer output is then processed by a demapper block, which converts equalizer samples into groups of symbols ready for Forward Error Correction (FEC) decoding. Finally, the demapped symbols are processed by an FEC decoder block, which aims to recover the transmitted bits from the input symbols.

The number of FEC decoding iterations is controlled by an FEC decoder controller. In some embodiments, the number of iterations for any algorithm used herein may be assessed by a controller, or by manual adjustment, or based on a projection of computational load. The controller may dynamically determine the optimal number of iterations based on real-time system conditions, available processing capacity, and performance requirements. Alternatively, the number of iterations may be manually configured by system administrators or network operators based on deployment-specific requirements and performance targets. In other embodiments, the system may project the computational load and adjust the number of iterations proactively to maintain optimal performance while staying within processing constraints.

The diagram demonstrates how various controller blocks may be used to vary the configuration of the receiver, allowing for dynamic adjustment of algorithmic complexity based on available processing resources.

It will be clear to those skilled in the art that this is simplified and covers a subset of functions typically found in a receiver, yet it is sufficient to convey the architecture of the present invention. The receiver can include, in some embodiments, one or more of the following.

A Channel Estimation (CE) block, to estimate the distortion to which the signal was subjected while travelling between the transmitter and receiver. The CE block analyzes reference signals or pilot symbols to characterize the wireless channel's frequency response, phase distortion, and amplitude variations caused by multipath propagation, fading, and other channel impairments. This channel state information is essential for subsequent equalization and signal recovery processes.

An anchor grid selection block. Typically, the output of CE is correlated in time and frequency. The goal of this block is to select a subset of CE outputs as a basis for calculating equalizer coefficients, trading off complexity and performance. The anchor grid represents a structured pattern of reference points distributed across time and frequency domains where channel estimation measurements are available. Since channel conditions typically exhibit correlation properties-meaning that channel characteristics at nearby time instants and frequency bins are similar—it is not necessary to use every available channel estimation output for equalizer coefficient calculation. The anchor grid selection block intelligently chooses which channel estimation outputs to retain as “anchor points” that will serve as the foundation for interpolating channel characteristics across the entire time-frequency grid. A denser anchor grid (with more closely spaced reference points) provides higher resolution channel tracking capability and more accurate equalizer coefficients, but requires significantly more computational resources for processing. Conversely, a sparser anchor grid (with fewer, more widely spaced reference points) reduces computational complexity but may result in less precise channel estimation, particularly in rapidly varying channel conditions. The selection strategy must balance these competing requirements, considering factors such as channel coherence time, coherence bandwidth, Doppler spread, delay spread, and available processing capacity. In the context of this invention, when Turbo Boost is active and additional processing capacity becomes available, the anchor grid selection block can opportunistically choose a denser grid configuration to improve channel estimation accuracy and overall system performance.

Equalizer. The goal of the equalizer is to form estimates of the transmitted signal samples by compensating for channel distortions and interference effects that occur during wireless transmission. The equalizer processes the received signal using channel state information provided by the channel estimation block to reverse the effects of multipath fading, frequency-selective distortion, and other channel impairments. Several equalizer variants will be known to those skilled in the art, including the MMSE equalizer and the MMSE-IRC equalizer.

The Minimum Mean Square Error (MMSE) equalizer represents a baseline equalization approach that minimizes the mean square error between the transmitted and received signal samples. The MMSE equalizer computes optimal linear filtering coefficients based on the estimated channel response and noise characteristics, providing a good balance between computational complexity and performance for typical channel conditions. This equalizer is particularly effective in scenarios with moderate interference levels and represents the standard approach used when processing resources are constrained.

The MMSE-Interference Rejection Combining (MMSE-IRC) equalizer is a more sophisticated and computationally intensive variant that extends the basic MMSE approach by explicitly modeling and suppressing interference from multiple sources. The MMSE-IRC equalizer constructs a more detailed interference covariance matrix that accounts for both thermal noise and structured interference patterns, such as inter-cell interference, co-channel interference, and other forms of signal contamination. This enhanced interference modeling enables the equalizer to perform spatial filtering that can significantly improve signal quality in interference-limited scenarios, particularly in dense cellular deployments or environments with strong co-channel interference. However, the MMSE-IRC approach requires substantially more computational resources due to the need to estimate, invert, and process larger covariance matrices, making it an ideal candidate for opportunistic activation when Turbo Boost provides additional processing capacity.

In the context of this invention, the equalizer selection controller can dynamically choose between these algorithmic variants based on the current Turbo Boost state, automatically switching to the more capable MMSE-IRC equalizer when additional processing capacity becomes available, thereby improving signal recovery performance without compromising real-time processing requirements when Turbo Boost is inactive.

Demapper block, to convert equalizer samples into groups of symbols ready for FEC decoding. The demapper block performs a critical signal processing function that bridges the gap between the analog-domain signal recovery performed by the equalizer and the digital error correction processing performed by the FEC decoder. After the equalizer has compensated for channel distortions and produced estimates of the transmitted signal samples, these samples exist as complex-valued constellation points that represent the modulated symbols transmitted by the user equipment.

The demapper block's primary responsibility is to convert these complex-valued equalizer output samples into discrete symbol decisions and associated reliability information that can be processed by the Forward Error Correction decoder. This conversion process involves several key operations depending on the modulation scheme employed, such as QPSK (Quadrature Phase Shift Keying), 16-QAM (Quadrature Amplitude Modulation), 64-QAM, or 256-QAM as specified in 3GPP standards.

For hard-decision demapping, the demapper examines each complex-valued sample from the equalizer and determines which constellation point it most closely represents, then outputs the corresponding bit pattern. However, modern wireless systems typically employ soft-decision demapping, which provides not only the most likely bit values but also reliability metrics (such as Log-Likelihood Ratios or LLRs) that quantify the confidence level of each bit decision. These reliability metrics are crucial for optimal performance of iterative FEC decoders like LDPC and Turbo codes, as they enable the decoder to weight its decisions based on the quality of the received signal.

The demapper must also account for the specific bit-to-symbol mapping (Gray coding) used in the modulation scheme, ensure proper scaling of the soft metrics based on noise estimates provided by the channel estimation block, and handle any constellation-specific processing requirements. In the context of this invention, while the demapper itself may not directly benefit from Turbo Boost-based algorithmic scaling, its output quality directly impacts the effectiveness of the subsequent FEC decoding process, which does benefit from the opportunistic use of additional processing capacity when Turbo Boost is active.

Forward Error Correction (FEC) decoder, aiming to recover the transmitted bits from input symbols by correcting errors that may have occurred during transmission through the wireless channel. The FEC decoder represents the final stage in the receiver chain where digital error correction techniques are applied to improve the reliability of data recovery. 3GPP standards include several FEC methods, each optimized for different scenarios and performance requirements. These include turbo codes, which use iterative decoding with two constituent convolutional encoders and provide excellent performance for 3G and 4G systems; LDPC (Low-Density Parity-Check) codes, which are the primary FEC method for 5G NR data channels and offer superior performance with lower complexity than turbo codes; convolutional codes, which provide basic error correction for control channels and legacy systems; polar codes, which are used for 5G NR control channels and offer theoretical optimality for certain channel conditions; and block codes, which provide simple error detection and correction for specific applications. In the context of this invention, iterative FEC decoders like turbo and LDPC codes are particularly well-suited for Turbo Boost-based algorithmic scaling, as their performance can be significantly enhanced by allowing additional decoding iterations when extra processing capacity becomes available, directly improving Block Error Ratio (BLER) performance and overall system throughput. Various algorithms for LDPC and turbo decoders are known in the art with different scaling characteristics.

Typically, some receiver functions will be configurable, where a block can be configured to follow a less performant and lower complexity path, or a more performant and higher complexity path. Several controller blocks are shown in FIG. 2 to vary the configuration.

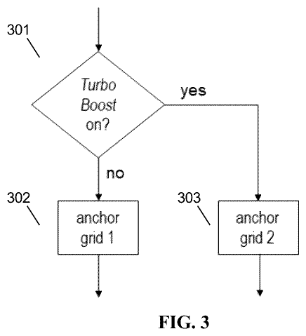

In one embodiment of the invention, shown in FIG. 3, Turbo Boost state is used to control the anchor grid selection. FIG. 3 illustrates a flowchart for a dynamic algorithm selection process based on Turbo Boost status. The process begins with an input signal entering a channel estimation block, which estimates the distortion to which the signal was subjected while traveling between the transmitter and receiver. The process then moves to a decision point where the Turbo Boost status is evaluated. If Turbo Boost is determined to be on (yes branch), the process proceeds to select anchor grid 2, which provides a denser grid compared to anchor grid 1 in either time or frequency or both. If Turbo Boost is determined to be off (no branch), the process proceeds to select anchor grid 1, which represents a baseline configuration with lower complexity. Both branches then continue to subsequent processing stages. The flowchart demonstrates how the system dynamically adjusts the anchor grid selection based on the availability of additional processing capacity provided by Turbo Boost, allowing for enhanced channel estimation resolution when additional computational resources are available while maintaining baseline performance when Turbo Boost is inactive.

In another embodiment, shown in FIG. 4, Turbo Boost state is used to control the equalizer selection. FIG. 4 illustrates a flowchart for a dynamic algorithm selection process based on Turbo Boost status. The process begins with an input signal entering the system. The process then moves to a decision point where the Turbo Boost status is evaluated. If Turbo Boost is determined to be active (yes branch), the process proceeds to equalizer 2, which represents a higher complexity and higher performance algorithm. If Turbo Boost is not active (no branch), the process proceeds to equalizer 1, which represents a baseline algorithm with lower complexity. Both paths then continue to subsequent processing stages. The flowchart demonstrates a method for opportunistically selecting between different algorithmic implementations based on available processing capacity, allowing the system to dynamically adjust computational complexity in response to processor performance states. An example of a higher-complexity and higher-performance algorithm is MMSE-IRC, compared to MMSE.

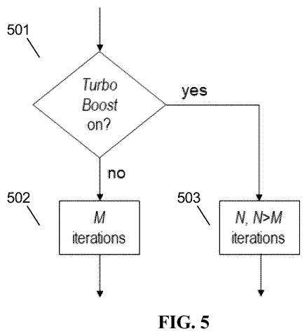

It will be known to those skilled in the art that some FEC decoders, including turbo and LDPC, follow an iterative process. Accordingly, in another embodiment, shown in FIG. 5, Turbo Boost state is used to control the number of FEC decoding iterations. FIG. 5 illustrates a flowchart for controlling the number of Forward Error Correction (FEC) decoding iterations based on Turbo Boost status. The process begins with an initial step where M iterations are performed. Following this, a decision point evaluates whether Turbo Boost is active. If Turbo Boost is not active (no branch), the process proceeds to perform M iterations and then continues to subsequent processing. If Turbo Boost is active (yes branch), the process performs N iterations, where N is greater than M, providing enhanced decoding performance. After completing the N iterations, the process continues to subsequent processing. The flowchart demonstrates an adaptive approach where the number of FEC decoding iterations dynamically adjusts based on available processing capacity, allowing for improved error correction performance when additional computational resources are available through Turbo Boost activation.

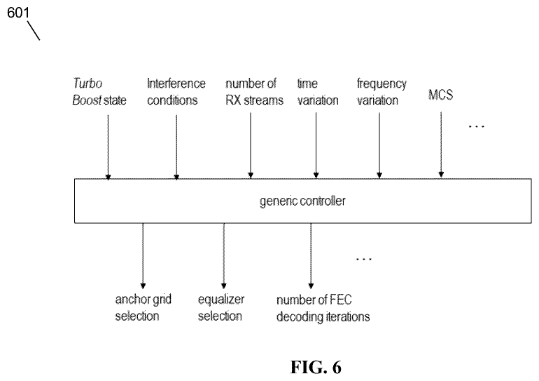

FIG. 6 is a flow diagram showing a controller block with multiple inputs, in accordance with some embodiments. The diagram shows a generic controller that receives multiple inputs and produces outputs to control various components of a physical layer receiver. The inputs to the generic controller include Turbo Boost state, interference conditions, number of RX streams, time variation, frequency variation, and MCS (Modulation and Coding Scheme). The generic controller processes these inputs to make decisions regarding system configuration. The outputs from the generic controller direct the configuration of three functional blocks: anchor grid selection, equalizer selection, and number of FEC decoding iterations. The anchor grid selection block determines the density and distribution of channel estimation reference points in time and frequency domains. The equalizer selection block chooses between different equalization algorithms based on the controller's decision. The number of FEC decoding iterations block adjusts the iterative decoding process for forward error correction. The diagram demonstrates how the controller integrates multiple system parameters and environmental conditions to dynamically optimize the receiver's signal processing configuration, enabling adaptive performance based on available processing resources and channel conditions.

It should be noted that, in general, controller decisions may be dictated by a number of factors in addition to Turbo Boost, as illustrated in FIG. 6. For example, under good channel conditions, a less performant block configuration may be sufficient to successfully recover the message, even if Turbo Boost is active. One or more of these other factors can be used in determining whether to use turbo boost self-scaling, in some embodiments. Other factors that can be used include, in some embodiments: signal-to-noise ratio (SNR), signal-to-interference-plus-noise ratio (SINR), channel quality indicator (CQI), modulation and coding scheme (MCS), number of receive antenna streams, Doppler spread, delay spread, user equipment velocity, cell load conditions, quality of service (QoS) requirements, latency constraints, power consumption targets, thermal conditions, and historical performance metrics.

In some embodiments, controller implementations may monitor energy consumption metrics alongside Turbo Boost state to balance energy savings with performance enhancement. Such controllers may track energy-per-bit metrics to quantify the efficiency improvements achieved through the dynamic self-scaling approach. By monitoring both performance metrics (such as BLER, throughput, and latency) and energy metrics (such as power consumption, energy per successfully decoded block, or energy per bit), the controller may make informed decisions about when to activate enhanced algorithms based on a holistic optimization objective that considers both performance and energy efficiency. In some cases, the controller may determine that baseline algorithms are sufficient even when Turbo Boost is active, particularly in scenarios where channel conditions are favorable and the energy cost of enhanced processing would outweigh the marginal performance benefit.

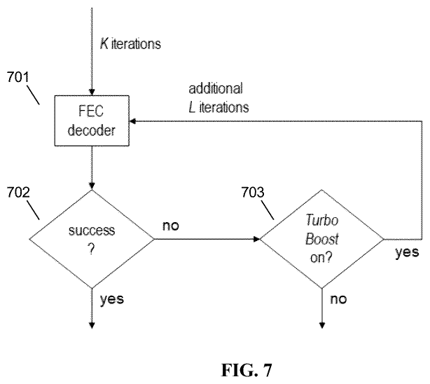

FIG. 7 illustrates a flowchart for a method of controlling Forward Error Correction (FEC) decoding iterations, where additional iterations may be scheduled opportunistically based on the status of decoder output and Turbo Boost. The process begins with K iterations being performed by the FEC decoder. Following the completion of these K iterations, the process moves to a decision point where the system determines whether the decoding was successful. If the decoding is successful (yes branch), the process terminates. If the decoding is not successful (no branch), the process proceeds to another decision point where the Turbo Boost status is evaluated. If Turbo Boost is determined to be active (yes branch), the process returns to the FEC decoder to perform additional L iterations. After these additional L iterations are completed, the process returns to the success evaluation decision point to determine whether the decoding was successful. If Turbo Boost is not active (no branch), the process terminates without performing additional iterations. The flowchart demonstrates an opportunistic scheduling mechanism where additional FEC decoding iterations may be performed based on both the decoder output status and the availability of Turbo Boost processing capacity. The process allows for dynamic adjustment of computational complexity, enabling improved error correction performance when additional processing resources are available through Turbo Boost activation.

It is assumed that there will be sufficient opportunities for Turbo Boost to be activated. This is expected e.g. (i) in lightly- or moderately-loaded scenarios or (ii) in scenarios where processing load is not equally distributed between CPU resources or (iii) in scenarios where some of the parallel processing tasks complete ahead of others, e.g. having been allocated a higher integrity signal.

In some embodiments, detecting the current Turbo Boost state of the processor in the base station may be performed by inspecting device Model Specific Registers (MSR). Model Specific Registers are processor-specific registers that provide access to various processor features and status information, including performance monitoring capabilities and power management states. To retrieve Turbo Boost status information from MSRs, software can execute processor-specific instructions such as the RDMSR (Read Model Specific Register) instruction on x86 architectures, which reads the contents of a specified MSR and returns the data to general-purpose registers. For Intel processors, relevant MSRs may include IA32_PERF_STATUS (0x198) which contains current performance state information, IA32_MISC_ENABLE (0x1A0) which controls various processor features including Turbo Boost enable/disable status, and IA32_TURBO_RATIO_LIMIT (0x1AD) which defines the maximum turbo frequency ratios. For AMD processors, similar functionality may be accessed through MSRs such as MSRC001_0015 (Hardware Configuration Register) and MSRC001_0061 (P-State Current Limit Register). The use of MSRs is particularly advantageous because it enables the creation of processor-dependent code sections that can execute on different models of CPU while being included in the same binary executable, allowing for adaptive detection algorithms that automatically adjust their MSR access patterns based on the detected processor type and model. This approach provides runtime flexibility without requiring separate binaries for different processor architectures. In some embodiments, command line utilities may be used in place of direct MSR access, such as the “rdmsr” utility on Linux systems, the “wrmsr” utility for writing to MSRs, or processor-specific monitoring tools like Intel's “turbostat” utility, which can provide Turbo Boost status information through higher-level interfaces that abstract the underlying MSR operations while still providing access to the same fundamental processor state information.

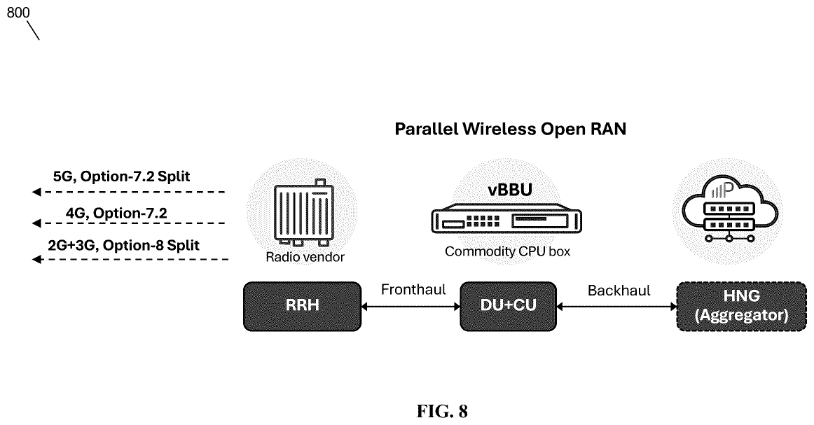

FIG. 8 is a schematic diagram of a multi-RAT RAN deployment architecture, in accordance with some embodiments. As shown, a single RRH supports a 5G RAT with an Option 7.2 split, a 4G RAT with an Option 7.2 split, and 2G+3G with an Option 8 split. With the Option 7.2 split, the PHY is split into High PHY and Low PHY. For option 7-2, the uplink (UL), CP removal, fast Fourier transform (FFT), digital beamforming (if applicable), and prefiltering (for PRACH (Physical Random Access Channel) only) functions all occur in the RU. The rest of the PHY is processed in the DU. For the downlink (DL), the inverse FFT (iFFT), CP addition, precoding functions, and digital beamforming (if applicable) occur in the RU, and the rest of the PHY processing happens in the DU. This is the preferred ORAN split for 5G, and can also be used for 4G. For 2G+3G, an Option 8 split is preferred, where only RF will be performed at the RU and further processing (PHY/MAC/RLC/PDCP) is performed at the vBBU. This is desirable because the processing and latency requirements for 2G and 3G are lower, and are readily fulfilled by a BBU or VBBU.

Continuing with FIG. 8, a fronthaul link connects the RRH to a DU+CU, which runs a variety of virtualized RAT processing on a vBBU machine. The fronthaul link may be CPRI or eCPRI, or another similar interface. The DU+CU may be located at the base of the tower or at a further remove as enabled by different latency envelopes; typically this will be close to the tower for a 5G deployment. In some embodiments, a HetNet Gateway (HNG), which performs control and user plane data aggregation and gateway services, may be the next destination via the backhaul connection; the HNG may disaggregate the different RAT communications to be directed to different RAT cores (i.e., a 2G core, a 3G core, a 4G core, a 5G core and so on). In some embodiments and in certain situations, an HNG may perform virtualization or interworking of aggregated communications such that, e.g., 2G communications may be interworked to 4G IP voice communications and routed through the 4G core. In some embodiments, the HNG may perform virtualization of one or more cores such that the communications may not need to terminate at a RAT-specific core; this feature may be combined with interworking in some embodiments. In some embodiments, no aggregator may be present and the vBBU may directly route communications to each RAT's individual core.

### ADDITIONAL EMBODIMENTS

The inventors have appreciated that the use of the 3GPP model for functional splits is flexible and may be used to provide deployment flexibility for multiple RATs, not just 5G. Functional splits can be used in conjunction with cloud and virtualization technology to perform virtualization of, e.g., the RU, DU, and CU of not just 5G but also 4G, 3G, 2G, etc. This enables the use of commodity off-the-shelf servers, software-defined networking that can be rapidly upgraded remotely, and lower power requirements by using modern hardware compared to legacy hardware.

The inventors have understood that, in some embodiments, additional more performant and higher complexity paths may be switched on for downlink (DL) PHY signal processing functions and/or MAC scheduler functions when using Turbo Boost, in accordance with and keeping in the spirit of the present disclosure.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods are described in reference to 3GPP, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 or ARM microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for dynamically self-scaling uplink physical layer (UL PHY) algorithms in a mobile communications base station, comprising:
detecting the current Turbo Boost state of a processor in the base station; and
executing an enhanced algorithm with greater complexity and increased processing demands, resulting in improved wireless performance, when Turbo Boost is active;
thereby enabling the mobile communications base station to opportunistically exploit additional processing capacity provided by Turbo Boost, thereby enhancing the performance of UL PHY algorithms.

2. The method of claim 1, further comprising executing a baseline algorithm with standard complexity when Turbo Boost is inactive; and executing an enhanced algorithm with greater complexity and increased processing demands, resulting in improved wireless performance, when Turbo Boost is active.

3. The method of claim 1, wherein the enhanced algorithm is selected from the group consisting of: increased Forward Error Correction (FEC) decoder iterations, increased channel estimation anchor density, and enhanced equalizer algorithms.

4. The method of claim 1, further comprising improving at least one of uplink Block Error Ratio (BLER), uplink data throughput, and channel estimation accuracy through the enhanced algorithm execution.

5. The method of claim 1, wherein detecting the current Turbo Boost state of the processor in the base station is performed by inspecting device Model Specific Registers (MSR).

6. The method of claim 1, wherein detecting the current Turbo Boost state of the processor in the base station is performed each time the UL PHY algorithms execute.

7. The method of claim 1, further comprising executing a baseline algorithm when Turbo Boost is inactive.

8. The method of claim 1, wherein the increased number of decoder iterations for 5G NR Low-Density Parity Check (LDPC) decoding and 4G LTE Turbo decoding, when Turbo Boost is active, improves the UL Block Error Ratio (BLER) and increases the UL data throughput.

9. The method of claim 1, further comprising allowing an increased number of decoder iterations for one of 5G NR Low-Density Parity Check (LDPC) decoding and 4G LTE Turbo decoding when Turbo Boost is active, thereby improving the UL Block Error Ratio (BLER) and increasing the UL data throughput.

10. The method of claim 1, further comprising employing an increased number of channel estimation anchors for one of 5G NR and 4G LTE channel estimation and equalization when Turbo Boost is active, thereby providing finer time-domain or frequency-domain resolution in an equalizer, leading to improved UL BLER performance and higher throughput.

11. The method of claim 1, further comprising selecting between the baseline Minimum Mean Square Error (MMSE) algorithm and a more sophisticated MMSE-Interference Rejection Combining (IRC) algorithm based on the Turbo Boost status.

12. The method of claim 1, further comprising determining a degree of boost in terms of a proportional increase in clock speed above the baseline, and tuning a enhanced algorithm using the determined degree of boost, wherein a higher degree of boost allows for a higher level of algorithmic complexity.

13. The method of claim 1, wherein the Turbo Boost state is used to control a number of Forward Error Correction (FEC) decoding iterations, allowing additional iterations to be scheduled opportunistically based on the status of decoder output and Turbo Boost.

14. A non-transitory computer-readable medium comprising instructions that, when executed at a mobile communications base station, cause the base station to perform steps comprising:
detecting the current Turbo Boost state of a processor in the base station; and
executing an enhanced algorithm with greater complexity and increased processing demands, resulting in improved wireless performance when Turbo Boost is active,
thereby enabling the mobile communications base station to opportunistically exploit additional processing capacity provided by Turbo Boost, and enhancing performance of uplink (UL) physical layer (PHY) algorithms.
